(19) United States
(12) Patent Application Publication
(10) Pub. No.: US 2024/0399995 A1
(43) Pub. Date: Dec. 5, 2024

(54) SMART TRAILER SECURITY AUTHORIZATION METHOD AND DEVICE

(71) Applicants: Alan Bruce Cornford, West Vancouver (CA); Harold Ishebabi, Burnaby (CA)

(72) Inventors: Alan Bruce Cornford, West Vancouver (CA); Harold Ishebabi, Burnaby (CA)

(21) Appl. No.: 18/204,331

(22) Filed: May 31, 2023

(51) Int. Cl. B60R 25/00; B60R 25/08

(52) U.S. Cl. CPC B60R 25/001; B60R 25/08; B60R 25/33

(57) ABSTRACT

A smart authorization system preventing a trailer from being pulled without authority either by activating, deactivating or blocking access to coupling devices or by maintaining parking conditions or temporarily disabling driving systems.

A smart authorization system preventing a trailer from being pulled without authority either by activating, deactivating or blocking access to coupling devices or by maintaining parking conditions or temporarily disabling driving systems.

### CROSS-REFERENCE TO RELATED APPLICATION

This application claims priority to, and the benefit of, U.S. Provisional Application 63/365,946 (“GLADLOCK, A REMOTE LOCK AND MANAGEMENT SYSTEM FOR TRAILERS”), filed on Jun. 6, 2022 the entire contents of which are incorporated herein by reference.

### FIELD

The invention relates generally to authorization methods and devices for securing heavy duty trailers and container chassis used in road transportation. It lies within the classification code B6OR25/102 which incorporates fittings or systems for preventing or indicating unauthorised use or theft of vehicles. More particularly, the invention relates to preventing such equipment from getting pulled without authorization either by blocking access to coupling devices or by temporarily disabling equipment's parking and/or driving systems.

### BACKGROUND

Hereafter, heavy duty tractors and yard jockeys will be referred to as Powered Equipment (PE), whereas heavy duty trailers and chassis will be referred to as Non-Powered Equipment (NPE).

In transportation, a Shipper is a company that contracts another company called a Carrier to haul goods from A to B. The Carrier dispatches a PE to pick up and drop NPE. To pull a NPE, a driver connects electric and air lines from the PE to the NPE. The problem is that any PE can connect to any NPE, there is no security mechanism.

Lack of security causes three problems: (i) unauthorized use, (ii) carrier non-compliance and (iii) safety. Unauthorized use is when a carrier picks an NPE they are not supposed to, which is then used to haul Shipper B's cargo at the expense of Shipper A. This can be both: (a) intentional, or (b) accidental. Non-compliance happens when a carrier selects an NPE belonging to the right Shipper or Operator, but not the one they are contracted to pull at that time. Non-compliance either leads to hauling to the wrong destination, or causes the Shipper to incur penalties for late return of rentals. Safety concerns happen when a PE connects to an NPE that is still docked, which can result to serious bodily harm or death to employees working in or around the NPE.

One form of prior art related to securing a NPE trailer consists of using physical locks that can prevent unauthorised connection by a PE tractor. However physical locks are impractical to use at scale due to a need for coordinating key handover or using employees to unlock an NPE with related safety and efficiency issues. Additionally, these NPEs are often parked at unsecured, distant locations which further complicates the use of physical locks.

Accordingly, there is a need for a remote authorization mechanism to prevent the wrong carrier from pulling the wrong NPE, the right carrier from pulling the wrong NPE, or the right carrier from pulling the right NPE that is not yet ready.

Prior art teaches methods for securing NPEs that consist of using physical external locks to try (1) to prevent unauthorised tractor connection to the NPE brake air line, (2) to prevent tampering with the airline gladhands or (3) to institute alternative methods that may interrupt or affect the braking system hydraulic line. Many of these patents focus on fittings or vehicle control systems for preventing or indicating unauthorised use. These systems may use various sensors, cameras, and communication protocols to detect and transmit about information the trailer's characteristics to the vehicle's control system or to a remote monitoring system.

One of these methods, U.S. Pat. No. 5,145,240 Sep. 8, 1992 describes a valve assembly that is designed to be coupled to a trailer air brake line to prevent a driver from deliberately or inadvertently moving the trailer from a parked position without an affirmative step being taken by a person in control of the trailer such as a dockman in charge of loading or unloading the trailer.

U.S. Pat. No. 6,338,534 Jan. 15, 2002 details a theft prevention system for trailers with the customary pneumatic trailer braking system. A normally closed solenoid valve is connected in the line that supplies air to release the trailer parking brakes and a signal receiver adapted to receive an electrical signal from a transmitter in the tractor cab must be caused to actuate the solenoid to open the valve to release the trailer parking brakes.

U.S. Pat. No. 7,344,202 Mar. 18, 2008 describes an air brake safety device which prevents supply of compressed air from a tractor from unlocking the air brakes on the trailer to allow the trailer to be driven away by the tractor while the workers are still working in the trailer. These safety devices usually employ two-way valves which, in one position, allow air from the compressor on the tractor to reach the brakes on the trailer to unlock the brakes and allow the trailer to be moved. In a second position, the device prevents all the air from the compressor from reaching the brakes and instead diverts some of the air from the compressor to the atmosphere.

U.S. patent application No. 20220055598A1 describes a lock for a trailer emergency air brake supply line coupler. And U.S. application No. 20070063582A1 describes a trailer isolator assembly for air brakes while U.S. application No. 20030006886A1 teaches a system for disabling vehicles having air brake systems.

However disabling the air brakes is not the only deterrent to avoiding hauling mistakes or trailer theft. There is a wide array of additional alternatives in the prior art which includes door locks, geofences, landing gear locks, camera systems, capacitive sensors, wheel locks, motion sensors and various alert and tracking systems. For example

U.S. application No. 202220341217A1 describes a robotic door lock; U.S. application No. 20220046381A1 describes a vehicle to everything dynamic geofence; U.S. application No. 20220017040A1 describes a trailer landing gear leg lock; U.S. application 20210237646A1 describes a 360 degree trailer camera view system; U.S. application 11024139B1 describes a capacitive sensor for cargo bed cap tampering detection; U.S. application No. 20210142588A1 provides a portable electronic wireless lock and lock system for efficiently managing and assuring the safety quality and security of goods stored within a truck, tractor or trailer transported by a roadway; U.S. application No. 20210086722A1 describes a vehicle anti-theft system and device for disabling one trailer wheel; U.S. application 20170282855A! teaches a wireless vehicle security motion sensor with a threaded mounting surface and related methods; U.S. RE43990-E teaches multi sensor detection, stall to stop and lock disabling system and U.S. application No. 20180222443A1 describes a vehicle alarm system with multiple devices while U.S. Pat. No. 5,969,433A1 describes a theft preventing and deterring system and method using a remote station to prevent opening the trailer doors.

There are also several warning and tracking systems such as U.S. Pat. No. 10,640,084B1 theft alert early warning and vehicle tracking system; U.S. application No. 20190073735A1 describes an enhanced alert/notification system for law enforcement identifying and tracking of stolen vehicles and cargo, and U.S. Pat. No. 7,586,401B2 teaches a system and method for vehicle theft prevention and U.S. Pat. No. 7,489,049B2 teaches an antitheft device.

Therefore there are a numerous variations of types of security devices capable of limiting or stopping activation or deactivation of the parking breaks as well as many alternative methods aimed at providing trailer security.

There are also prior art patents describing aspects of authorization systems, methods or devices that communicate either by hardwired or remote means the authorizations and/or instructions necessary to control and activate or deactivate the physical security devices or employ the desired security processes. There is also prior art describing general communications between tractors and trailers that collect and report a multitude of trailer sensor data that are generally classified as components of smart trailer systems. One key aspect within these systems are authorization protocols. The patent classification subcodes B6OR25/102 and B6OW 10/188 further describe many of the fittings or systems for preventing or indicating unauthorised use or theft of vehicles actuating a signalling device, a signal being sent to a remote location, e.g. a radio signal being transmitted to a police station, a security company or the owner. Examples of prior art that describe these types of communication systems such as EP0505266A1 Sep. 23 1992 that describes a central system for controlled decommissioning of moveable or mobile equipment by an owner or authorized subscriber monitoring and/or remote intervention point.

Many sensors, devices and network communication system methods are progressively being incorporated and integrated into smart trailer internet of things (IoT) systems. Prior art examples include:

U.S. application No. 20220197255A1 which provides methods and systems for the industrial internet of things and U.S. Pat. No. 10,848,944B2 which provides internet of things unification and verification.

U.S. Pat. No. 10,858,053 Oct. 9, 2017—Smart trailer system—assigned to Phillips Connect Technologies LLC describes a smart trailer system coupled to a trailer of a vehicle that includes a sensor configured to measure a parameter of the trailer, a sensor interface board electrically coupled to the sensor and configured to retrieve the measured parameter, and a master controller communicatively coupled to the sensor interface board via a data bus. The smart trailer system is coupled to a trailer of a vehicle. The smart trailer system has an air brake lock system comprising: a pressure sensor configured to monitor an air pressure of a brake system of the trailer; and an air brake actuator configured to selectively engage and disengage an airline to the brake system; and a controller communicatively coupled to the pressure sensor and the air brake actuator and configured to determine motion of the trailer based on speed data from a remote server and/or speed data received from an accelerometer sensor in the trailer, wherein, in response to determining motion of the trailer, the controller is configured to disengage the air brake lock system.

There are also several patents that describe additional aspects of smart trailer electronic communication systems:

U.S. Pat. No. 7,932,815B2 May 26, 2011 assigned to Intermec IP Corp-Wireless Tractor-Trailer Communications-describes computer-readable media, systems, and methods for wirelessly communicating between a tractor and a set of trailers in a tractor-trailer environment. In embodiments, a tractor wireless communication device associated with a tractor is initialized and associated with a tractor initialization time. Additionally, a trailer wireless communication device associated with at least one trailer is initialized and associated with a trailer initialization time.

U.S. Pat. No. 11,368,825 Jun. 21, 2022 assigned to Geotab describes a method, device, and system for managing a fleet of vehicles. The method includes providing a telematics device for an electric vehicle of the fleet of vehicles, the telematics device being capable of obtaining data from the electric vehicle; using the telematics device to identify the electric vehicle based on the data obtained from the electric vehicle; providing a data definition set for the electric vehicle to the telematics device; and using the telematics device and the data definition set to determine whether the electric vehicle is in a vehicle mode based on the data obtained from the electric vehicle and the data definition set. The vehicle mode of the electric vehicle can be at least one of a charging mode, a driving mode, and a parked mode.

U.S. Pat. No. 11,487,315 Nov. 1, 2022 assigned to Geotab provides a method and a system for impact detection in a stationary vehicle. The method includes putting a telematics device into a sleep mode, performing at least one micro wakeup, determining at least one value from at least one sensor during the micro wakeup.

U.S. Pat. No. 11,613,265 Mar. 28, 2023 assigned to Geotab describes a system, apparatus, device and methods relating to a telematic vehicle sharing platform ecosystem and a telematic vehicle share I/O expander to automate sharing and management of a vehicle that is shared by more than one operator.

US patent 11,641,063 May 2, 2023 assigned to Geotab Inc. describes how vehicles can employ onboard telematic monitoring devices to collect vehicle and operation data, such as for improved vehicle fleet management.

U.S. Pat. No. 11,623,655 Apr. 11, 2023 assigned to Geotab provides systems and methods for restricting the use of vehicle operator's electronic device. In a method by a telematics server, the server determines that a vehicle's engine is running and that the operator registered with the vehicle is in the driver's seat.

U.S. Pat. No. 11,640,577 May 2, 2023 assigned to Geotab describes methods, systems, and devices for data capture instructions for asset tracking. An example method for capturing data involves obtaining raw data from a data source on board an asset and monitoring the raw data for satisfaction of a simplified data capture trigger.

U.S. Pat. No. 11,479,312 Oct. 25, 2022-Smart Trailer System—assigned to Phillips Connect Technologies LLC describes a smart trailer system coupled to a trailer of a vehicle that includes a sensor configured to measure a parameter of the trailer, a sensor interface board electrically coupled to the sensor and configured to retrieve the measured parameter, and a master controller communicatively coupled to the sensor interface board via a data bus. U.S. application 20230041140A1 assigned to Phillips Connect also describes a smart trailer system as does U.S. Pat. No. 11,526,166B2 and U.S. Pat. No. 11,479,312B2 and U.S. application No. 202110302541A1 describes modular sensor assembly for vehicles.

U.S. Pat. No. 11,451,957 Sep. 20, 2022 assigned to Phillips Connect Technologies LLC describes a method for traffic management of proprietary data in a network system comprising a gateway and a sensor communicatively coupled to the gateway via a data bus.

U.S. Pat. No. 10,858,053 Dec. 8, 2020-Smart Trailer System—assigned to Phillips Connect Technologies LLC describes a smart trailer system coupled to a trailer of a vehicle that includes a sensor configured to measure a parameter of the trailer, a sensor interface board electrically coupled to the sensor and configured to retrieve the measured parameter, and a master controller communicatively coupled to the sensor interface board via a data bus.

U.S. Pat. No. 10,647,369 May 12, 2020-Modular Harness System—assigned to Phillips Connect LLC describes an electrical harness system for communicatively coupling a first bus node to a bus controller.

U.S. Pat. No. 10,858,053 Dec. 8, 2020 assigned to Phillips Connect Technologies LLC claims a smart trailer system coupled to a trailer of a vehicle, the smart trailer system comprising a sensor coupled to the trailer and configured to measure a parameter of the trailer; a sensor interface board (SIB) electrically coupled to the sensor and configured to control the sensor and to generate sensed data based on the measured parameter; and a controller communicatively coupled to the SIB via a data bus, and configured to aggregate the sensed data. U.S. Pat. No. 11,455,870B2 describes automated monitoring, detection, and reporting of unauthorized movement and/or theft of vehicles and cargo and U.S. application No. 202220011749A1 describes intelligent controller and sensor network bus, system and method including a message retransmission mechanism and U.S. application 20210306366A1 describes remote configuration of security gateways.

There are also prior art examples of trailer and cargo yard authorization methods and devices for existing transport systems as well as these newer smart trailer and autonomous vehicle management systems. For example U.S. application No. 20230066866A1 describes systems and methods for automated operation and handling of autonomous trucks and trailers hauled thereby. U.S. application No. 20230159041A1 describes a vehicle safety system for autonomous vehicles and U.S. Pat. No. 11,270,538B2 teaches control, monitoring, and/or security, apparatus and method for premises, vehicles and/or articles and U.S. Pat. No. 11,618,414 describes a method of vehicle theft detection.

U.S. Pat. No. 11,548,743B2 and U.S. application No. 20230095890A1 teach remote loading dock authorization systems and methods. U.S. Pat. No. 11,505,161B2 also describes authenticating privilege elevation on a transportation service wherein it provides access to a set of control systems that are slightly different from the claims in the present invention.

U.S. application No. 20230037215A1 and U.S. Pat. No. 11,468,721B2 describes guest access for a locking device wherein the latter differs from the present invention that grants authorization from a logistics system while the prior art applies authorization only between a mobile device and an electronic lock.

U.S. application No. 2022284082A1 describes authentication challenges based on fraud initiation requests and U.S. Pat. No. 11,423,417B2 describes a method and system for auditing and verifying vehicle identification number (VINS) on transport devices with audit fraud detection.

U.S. Pat. No. 11,392,921B2 provides authenticating based on a device identifier; U.S. application No. 20220188397A1 describes delayed two-factor authentication in a networked environment; U.S. Pat. No. 11,554,750B2 describes multifactor authentication for vehicle operation; U.S. 11354663B2 describes electronic authentication systems; U.S. 10846694B2 describes offline authentication; U.S. application 20200334659A1 describes authenticating based on a device identifier; U.S. 10789595B2 teaches pseudo authorization messages; and U.S. Pat. No. 10,779,115B1 describes systems and methods for dynamically delivering access credentials for locking systems.

U.S. application No. 20220210604A1 and U.S. Pat. No. 11,304,027B2 describes systems and methods for delivering access credentials for locking systems, and U.S. application No. 20220014900A1 teaches techniques for provisioning an enterprise electronic subscriber identity module (ESIM); U.S. Pat. No. 11,100,211B2 describes devices, systems and methods for remote authorization of vehicle platooning, while U.S. Pat. No. 11,086,810B2 provides intelligent controller and sensor network bus, system and method including multi-layer platform security architecture.

The present invention is not taught in this prior art. This invention describes and teaches a novel method and device for the remote electronic authorization of both activation and deactivation of security devices in a smart trailer network and more specifically in the air brake hydraulic system as well as in a combination security system involving the hydraulic air brake system, the landing gear and internal rear door locking system of an NPE.

### SUMMARY

Certain features, aspects and examples disclosed herein are directed to a method of granting authorization and providing proof of authorization to a specific PE for pulling a specific NPE. Certain features, aspects and examples disclosed herein are directed to a system, method and device for unlocking an NPE using the aforementioned system, method and device of authorization. Additional features, aspects and examples are discussed in more detail herein.

In accordance to the first aspect, (i) a system, method and device authorization (ii) proof of for granting and providing authorization on a computing system central processing unit (CPU) is disclosed. The computing system CPU device includes a management subsystem 110, a PE identification module 120 and an NPE security subsystem 130. The method includes remotely unlocking an NPE via the management subsystem 110. The method further includes local unlocking of an NPE via the PE identification module 120.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be illustrative only.

FIG. 1 is a block diagram of a network of computer systems including the management module 110 which is a network of servers, owned by different entities, and installed at different locations, the PE identification module 120 installed on the tractor, and security subsystem module 130, which is a system of distributed components installed on the trailer according to one exemplary embodiment of the invention.

FIG. 2 is a block diagram of an embodiment of a trailer security lock module 133 and tractor authorization module 132, according to an exemplary embodiment of the present invention.

### DETAILED DESCRIPTION OF THE DRAWINGS

The detailed description set forth below in connection with the appended drawings is intended as a description of illustrative embodiments of a smart trailer authorization system and method in accordance with the present invention, and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention.

The authorization system may be designed to provide a simple interface to existing fleet management systems and APIs for NPEs and full fleets without an existing management system, and to provide comprehensive security and maintenance information to the fleet manager and vehicle operator (e.g., driver).

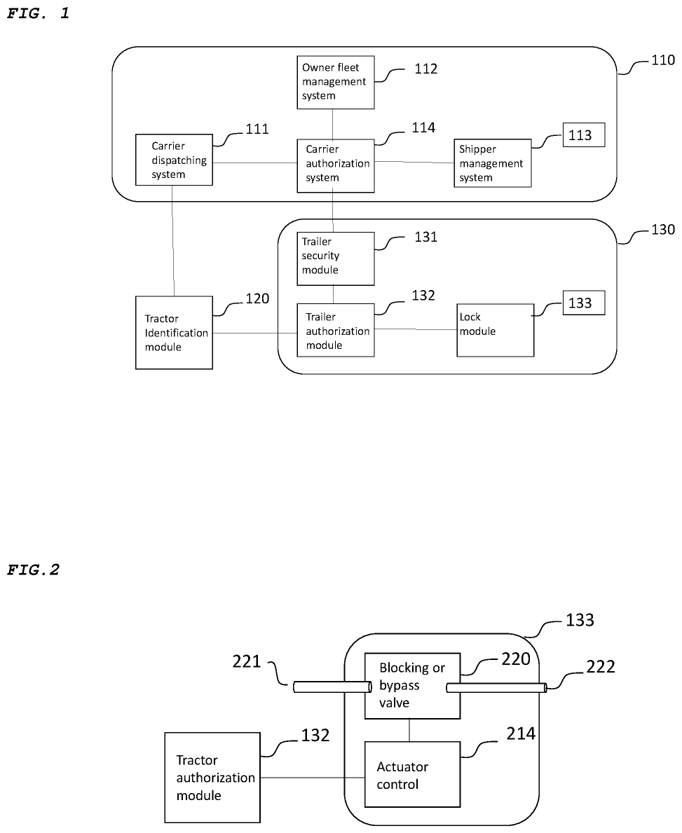

FIG. 1 is a block diagram of a network of computer systems including the management module 110 which is a network of servers, owned by different entities, and installed at different locations, the PE identification module 120 installed on the tractor, and security subsystem module 130, which is a system of distributed components installed on the trailer according to one exemplary embodiment of the invention.

In some embodiments, the management subsystem 110 further includes a carrier dispatching subsystem 111 (CDS), owner fleet management system 112 (OFM), a shipper management system 113 (SMS), and a carrier authorization system 114 (CAS).

In one embodiment, CDS may provide device features through which the carrier can specify information to CAS on which PE is assigned to execute which haul job is contracted to the carrier. The haul job may be specified in the device CPU using a unique haul ID, which may be generated in SMS by the shipper and may be communicated to SDS and CAS. In accordance to this exemplary embodiment, CAS may receive from SMS information on which NPE is assigned which haul ID, and use that information to build or maintain a list of PE-NPE authorization. CAS may store that list in its storage, or may share a part or the complete list with Tractor Authorization Module 132 (TAM). Where an authorization list is used, TAM may receive PE identification from Tractor Identification Module 120 (TIM). TIM uniquely identifies a PE using methods such as optical character recognition to read identifying marks such as license plate, or wireless proximity detection such as RFID tags or Bluetooth beacons uniquely registered to the PE or to the Carrier. TAM may cross check PE identification against the authorization list stored in its storage, or may forward that information to CAS which then cross checks the authorization. The authorization may further include a validity time window and the applicable geographical area using means such as geofencing by a satellite navigation system or triangulation of ground-based radio signals.

In either case, if there is an authorization, TAM may send unlock signal to the Lock Module 133 (LM) whose function is further disclosed in the second aspect of the present invention.

In other embodiments, CAS may provide functionality to CDS, OFM or SMS to directly send an unlock command to TAM. The direct unlock signal may further include instructions to TAM to verify PE identity via TIM 120, or to share the PE identity to CDS, OFM or SMS prior to these systems to authorize unlocking.

In other embodiments, TAM may include a human interface such as a PIN pad or user interface device for a driver to enter PE identification information, load ID or authorization code to effect unlocking via LM 133. In this example, the PE is identified via the PIN which is pre-assigned by CAS and stored in TAM's storage.

In accordance to the second aspect, a computing system CPU for unlocking an NPE is disclosed. The computing system CPU 133 (LM) includes Actuator Control 214 (AC) and a FIG. 2 Lock Device 220. AC may receive unlock commands from TAM to send actuating signal to the Lock Device, which may be electrical, pneumatic, optical, hydraulic or wireless. The Lock Device 220 serves the function of blocking PE driving systems such as brakes or landing gear wherein the pre-authorization will prevent the landing gear from being raised, rather than lock the air brakes for example.

In one embodiment, the Lock Device 220 includes a mechanical valve which may be actuated by electrical signal. In accordance to this exemplary embodiment, the valve may be installed in a manner such that AC can open or close the NPE's emergency air line. In this example, the valve is placed such that PE emergency air line may be connected to the valve via air line 221 and NPE's emergency air system may be connected to the valve via air line 222. When the emergency air line 222 is closed, a PE is prevented from pressurizing the emergency air line by blocking the path of air, which causes NPE's parking brakes to remain engaged. When AC 214 opens the valve in the Lock Device 220, the PE can pressurize the NPE's emergency system, which then disengages the parking brakes.

In other embodiments, the authorization system may release any type of mechanical device that may prevent the springs on brakes from moving since the locking mechanism is arbitrary to the authorization invention.

In the exemplary manner described above, the Lock Device 220 acts like a switch for the air brake system which can only be activated or deactivated by the authorization system identification code. The Lock Device 220 may similarly include a switch for isolating an electric or an hydraulic brake system.

1. A method of pre-authorizing powered equipment tractors, to link to non-powered equipment trailers comprising:
Communicatively coupling at least one carrier, shipper, owner or operator logistics computing system to at least one of a carrier authorization computing system (CAS), wherein the CAS receives from the upstream CAS logistics systems grant data or an instruction or a combination of a grant and instruction, the grant data including at least one data information element, designated herein grant data (GD) identifying the PE, its owner or operating company, its operating driver and/or certified drivers, haul contract information, dispatch information, carrier appointment, lease information, a validity time window, an applicable geographical area, wherein the CAS is communicatively coupled to a non-powered equipment trailer security system installed on the non-powered equipment trailer,
the non-powered equipment trailer security system comprised of a physical device for blocking or disabling non-powered equipment trailer movement and/or driving systems, and a computing device configured to receive from the CAS grant data and instructions to secure or unsecure the non-powered equipment trailer,
the authorization computing device further configured to cause the blocking or disabling of one or more physical devices to secure or unsecure the non-powered equipment trailer in accordance with the received instruction or grant data,
wherein the computing device may further be configured to identify a powered equipment within communication proximity of an non-powered equipment trailer by comparing the grant data to powered equipment identification information received via at least one of an optical sensor, sound sensor, electromagnetic receiver or a physical input device, collectively referred to as Identification Devices, wherein the identification device is coupled to the computing device electrically, optically, electromagnetically, or sonically, and
the pre-authorization is either for the powered equipment, its driver, its owner, its operating company, or any combination thereof.

2. A method as claimed in claim 1, wherein the grant is created in advance of the powered equipment arriving at the non-powered equipment trailer and is stored in the CAS, in the non-powered equipment trailer security system or in one of the upstream logistics computing systems.

3. A method as claimed in claim 1, wherein at least one of a device installed on the powered equipment or a mobile device is configured to transmit powered equipment identifying information to at least the CAS, the non-powered equipment trailer security system or one of upstream logistics computing systems.

4. A method as claimed in claim 2, wherein at least one of CAS or upstream logistics computing system is configured to be able to cause the blocking or disabling device to secure or unsecure the NPE trailer in accordance with the received identifying information.

5. A method as claimed in claim 1, wherein the grant is created after or upon the powered equipment arriving at the non-powered equipment trailer.

6. A method as claimed in claim 1, wherein the grant is issued to at least one of a plurality of PEs, drivers, their respective owning company, and/or their respective operating companies.

7. A method as claimed in claim 1, where the grant may have a validity time and may be created or revoked at any time and the grant may be temporary or permanent.

8. A method as claimed in claim 1, where the grant may have a validity geographical area.

9. A non-powered equipment trailer, security device, comprising:
a physical device for blocking or disabling non-powered equipment trailer movement and/or driving systems,
a computing device configured receive from the authorization computing system (CAS) at least one of grant data or instructions to secure or unsecure the non-powered equipment trailer from moving,
the computing device further configured to cause the enabling or disabling of the physical device to secure or unsecure the non-powered equipment trailer in accordance with the received instruction or grant data,
wherein the computing device may further be configured to identify a proximity powered equipment tractor by comparing the grant data to powered equipment identifying information received via at least one of an optical sensor, sound sensor, electromagnetic receiver or a physical input device, wherein these are coupled to the computing device electrically, optically, electromagnetically, or sonically.

10. A device as claimed in claim 9 wherein the computing device secures the non-powered equipment trailer by causing an hydraulic air line blocking or bypass valve to actuate to prevent the powered equipment tractor from releasing the non-powered equipment trailer parking brakes.

11. A device as claimed in claim 9, wherein the computing device secures the non-powered equipment trailer by actuating the non-powered equipment trailer service brakes.

12. A device as claimed in claim 9 wherein the computing device secures the non-powered equipment trailer by causing an hydraulic air line blocking or bypass valve to actuate to prevent the powered equipment from releasing the non-powered equipment trailer parking brakes.

13. A device as claimed in claim 10, wherein the computing device secures the non-powered equipment trailer by preventing the landing gear from getting raised.

14. A device as claimed in claim 10, wherein the computing device secures the trailer by mechanically blocking access to at least one of non-powered equipment trailer's coupling pin, electric line coupling, emergency line coupling or service line coupling.

15. A device claimed in claim 13 wherein the computing device also electronically locks the non-powered equipment trailer's cargo door from the inside to prevent access to the interior and to the cargo of the non-powered equipment trailer to further deter movement or theft of the non-powered equipment and its cargo.
